(19) United States
(12) Patent Application Publication
(10) Pub. No.: US 2008/0120139 A1
(43) Pub. Date: May 22, 2008

(54) Method of managing employee healthcare for an employer involving a marketing entity

(75) Inventor: Thomas Banks, Laguna Niguel, CA (US)

Correspondence Address: STETINA BRUNDA GARRED & BRUCKER, 75 ENTERPRISE, SUITE 250, ALISO VIEJO, CA, 92656, US

(73) Assignee: Flexscan, Inc.

(21) Appl. No.: 11/602,673

(22) Filed: Nov. 21, 2006

(51) Int. Cl. G06Q 30/00; G06Q 50/00; G06Q 99/00

(52) U.S. Cl. 705/3; 705/14; 705/10

(57) ABSTRACT

According to an aspect of the present invention, there is provided a method for managing employee healthcare for an employer. The method initially provides for receiving healthcare benefit information from a healthcare insurer. The healthcare insurer provides healthcare benefits to employees of the employer. Medical history information is received from the employees. The medical history information and the healthcare benefit information are stored in an online database. Access to the online database is provided to a marketing entity. Tailored marketing data based upon the medical history information of each of the employees is received from the marketing entity. Access to the medical history information and the healthcare benefit information is provided to the employees on a website. The website respectively displays the tailored marketing data to the employees on the website, when the employees respectively access any of the medical history information and healthcare benefit information.

### CROSS-REFERENCE TO RELATED APPLICATIONS

Not Applicable

### STATEMENT RE: FEDERALLY SPONSORED RESEARCH/DEVELOPMENT

Not Applicable

### FIELD OF THE INVENTION

The method of the present invention relates generally to managing employee healthcare for an employer involving a marketing entity. More particularly, the method may reduce and contain healthcare cost of an employer by facilitating an exchange of information between employees and a marketing entity, and thereby providing incentives to the employer and the employees.

### BACKGROUND

Providing healthcare benefits to employees is an essential task of an employer regardless of size. Providing healthcare benefits not only attracts new talents but also keeps the current employees comfortable so that they retain their efficiency and loyalty to the employer. However, managing employee healthcare is one of the challenges many employers face in today's business world. The government places upon U.S. businesses the burden of being the default caretaker of the healthcare system. Such role not only hinders the operation of the businesses, but also dilutes attention from primary duty of management, pursuing efficient and profitable production and sales. Dealing with healthcare providers may further divert attention from a company's business objective and diminish shareholder value by consuming the company's valuable resources. Further, healthcare premiums paid to healthcare insurers place significant financial burden upon the employer and directly impact the profitability of the business. As the healthcare premiums continues to climb yearly at a significant pace, many employers may have harder times providing healthcare benefits to their employees.

Many employers have taken on the strategy of moving part of the healthcare burden to the employees, by increasing the employees' out-of-pocket expenses for healthcare. However, such efforts have been mostly futile because of the rising healthcare cost and the occurrences of out-of-control diseases, such as lung cancer and heart diseases. Despite their efforts, employer health premium continues to rise even when employee contribution to healthcare insurance has gone up considerably. As the population in U.S. continues to grow, the employee healthcare cost crisis may become more severe. Aging workforce and lack of preventive care may further drive up healthcare costs. Achieving a balance between providing a well-managed healthcare system to keep the employees healthy, efficient, and loyal, and providing healthcare benefits at a reasonable cost, is difficult but important.

As such, there is a need in the art for a method of managing employee healthcare that alleviates the employee healthcare burden for an employer by helping the employers dealing with healthcare insurers and reduce payment of healthcare premiums, and allow the employer to focus on core business responsibility and operation efficiency. There is also a need in the art for a method of managing employee healthcare that allows the employees to take control of their own health by focusing on preventive care and reducing chances of catastrophic diseases.

### SUMMARY OF THE INVENTION

According to an aspect of the present invention, there is provided a method for managing employee healthcare for an employer. The method initially provides for receiving healthcare benefit information from a healthcare insurer. The healthcare insurer provides healthcare benefits to employees of the employer. Medical history information is received from the employees. The medical history information and the healthcare benefit information are stored in an online database. Access to the online database is provided to a marketing entity. Tailored marketing data based upon the medical history information of each of the employees is received from the marketing entity. Access to the medical history information and the healthcare benefit information is provided to the employees on a website. The website respectively displays the tailored marketing data to the employees on the website, when the employees respectively access any of the medical history information and healthcare benefit information.

According to various embodiments, the healthcare benefit information may be received electronically via a computer network. The medical history information may also be received electronically via a computer network. Access to the online database to the marketing entity may be provided through a marketing interface on the website. The marketing interface displays the medical history information to the marketing entity. The tailored marketing data may be received electronically via a computer network. The marketing entity may be a research facility. The marketing entity may also be a drug manufacturer. The tailored marketing data may be a banner advertisement on the website. Nutritional intake information may be received from the employees. Access to tailored workout programs to the employees may be provided on the website. The tailored workout programs may be generated based upon the nutritional intake information of each of the employees. Access to tailored diet plans may be provided to the employees on the website. The tailored diet plans may be generated based upon the nutritional intake information of each of the employees. A licensing revenue may be received from the marketing entity. The licensing revenue may be generated from providing access to the online database to the marketing entity. A first percentage of the licensing revenue may be forwarded to the employer. A second percentage of the licensing revenue may be forwarded to the employees. A third percentage of the licensing revenue may be forwarded to the healthcare insurer.

The method of the present invention may further provide for receiving health indicator data from the employees. Access to tailored health risk information may be provided to the employees on the website. The tailored health risk information may be computed based upon the health indicator data of each of the employees. A marketing survey may be provided to the employees on the website. Marketing survey data may be received from the employees. The marketing survey data may be provided to the marketing entity. A rebate may be received from the marketing entity. The rebate may be forwarded to the employees.

The method of the present invention may further provide for receiving nutritional intake information from the employees. Access to tailored workout programs may be provided to the employees on the website, the tailored workout programs being generated based upon the nutritional intake information of each of the employees. Access to tailored diet plans may also be provided to the employees on the website, the tailored diet plans being generated based upon the nutritional intake information of each of the employees.

The method of the present invention may further provide for receiving a licensing revenue from the marketing entity, the licensing revenue being generated from providing access to the online database to the marketing entity. A percentage of the licensing revenue may be forwarded to the employer.

The method of the present invention may further provide for receiving health indicator data from the employees. The health indicator data may be received electronically via the internet or a computer network. Access to tailored health risk information is provided to the employees on the website, the tailored health risk information being computed based upon the health indicator data of each of the employees.

The method of the present invention may further include providing a marketing survey to the employees on the website. After receiving the marketing survey data from the employees, which may be received electronically via the internet or a computer network, the marketing survey data may be provided to the marketing entity. A rebate may be received from the marketing entity, the rebate being generated from providing the marketing survey data to the marketing entity. A first portion of the rebate may be forwarded to the employees. A second portion of the rebate may be forwarded to the employer. The marketing survey data may also be provided to the marketing entity via the internet or a computer network.

The method of the current invention may further include receiving medical record data from a professional healthcare entity, with the professional healthcare entity providing healthcare service to the employees. Prescription data of each of the employees may be received from the professional healthcare entity. Medication may be provided to the employees based on the prescription data of each of the employees.

As such, based on the foregoing, the present invention mitigates the inefficiencies and limitations associated with prior art methods of managing employer and employee healthcare for an organization. In this respect, the present invention is specifically tailored to enhance those traditional methods of managing employee healthcare for an employer. Thus, the method of the present invention represents a business model which may greatly enhance traditional methods of managing employee healthcare for an employer.

The method of the present invention may facilitate the reduction of employer healthcare cost by allowing the employees to take control of their own health. By providing access to medical history information to the employees, allowing the employees to track their nutritional intake and health indicator data and providing tailored workout programs and diet plans, the employees may better monitor the status of their health, and improve their health by following the diet plans and workout programs provided by the website.

The method of the present invention may also facilitate the reduction of employer healthcare cost by licensing the medical history information, health indicator data, and nutritional intake information of the employees to the marketing entity. In return, the marketing entity may compensate the employer, the employees and the employer's healthcare insurer by providing a licensing revenue and offset the healthcare premium paid to the healthcare insurer by the employer and the employees. The method may further offset the healthcare premium by providing marketing activities to the employees and receive additional compensations from the marketing entity.

Accordingly, the present invention represent a significant advance in the art.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flow chart illustrating the method of managing employee healthcare of the present invention involving a marketing entity, the flow chart relationally depicts those flow of information;

FIG. 2 is a flow chart illustrating the flow of payments and compensations;

FIG. 3 depicts a sample wellness webpage displaying medical history information of an employee and a banner advertisement;

FIG. 4 depicts a sample medical history information form for gathering medical history information from the employees;

FIG. 5 depicts a sample diet plan generated based upon an employee's nutritional intake information;

FIG. 6 depicts a sample rebate provided to the employees.

### DETAILED DESCRIPTION OF THE PREFERRED EMBODIMENT

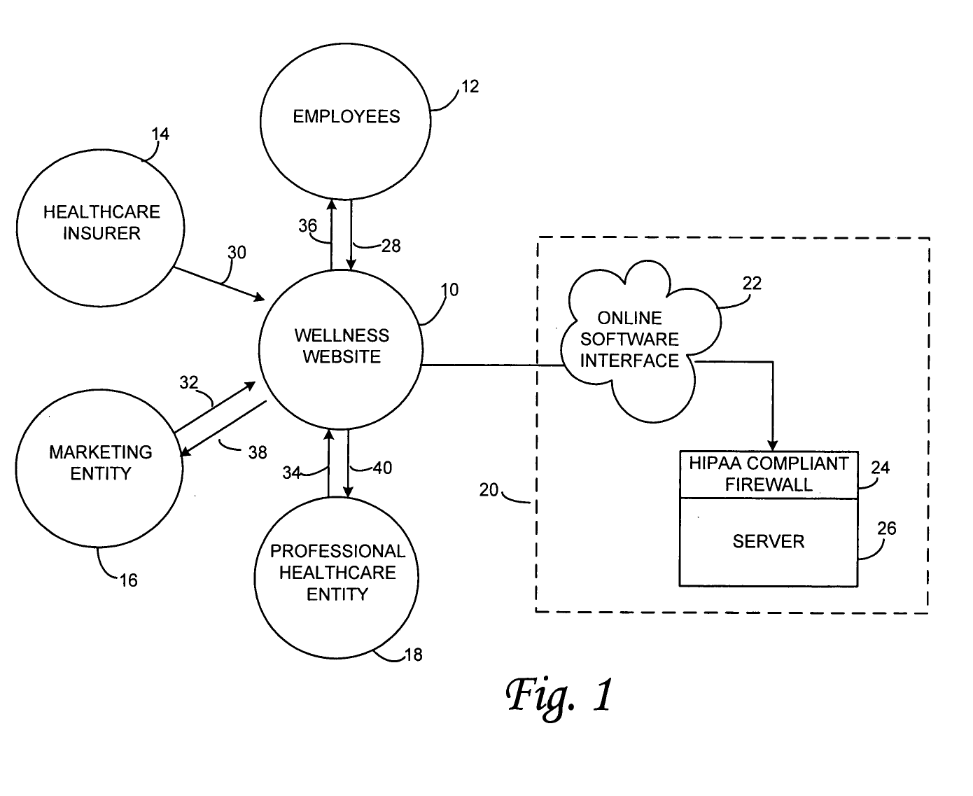

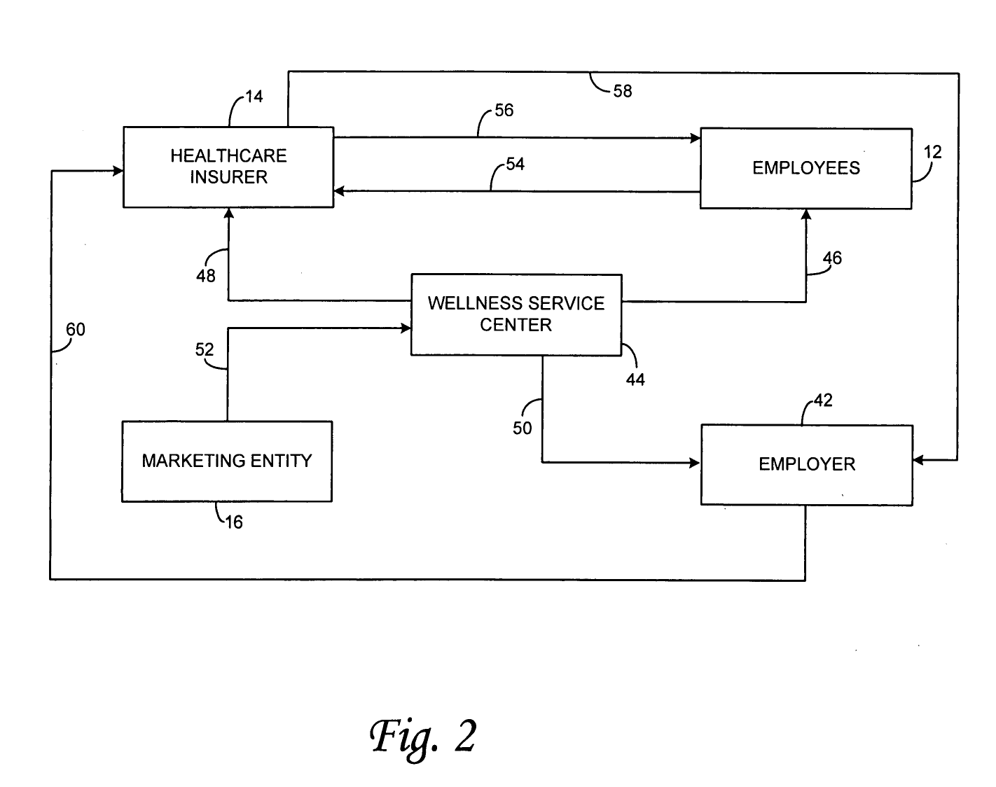

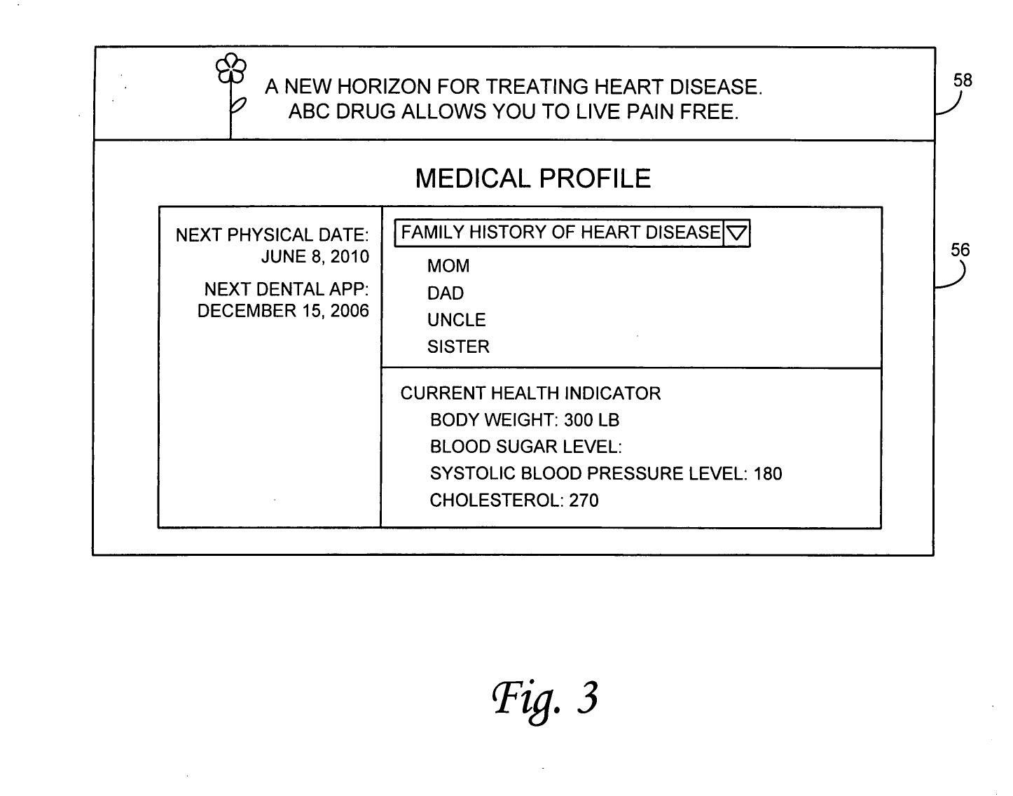

Referring now to the drawings wherein the showings are for purposes of illustrating a preferred embodiment of the present invention only, and not for purpose of limiting the same, FIGS. 1-2 illustrate a business model for implementing the method of the present invention. FIG. 3-6 provides sample web displays and employee rebate.

Referring now to FIG. 1, there is a diagram symbolically illustrating the information flow of a business model of the present invention for implementing a method for managing employee healthcare for an employer. The wellness website 10 serves as the processor of all information received from all other entities. The wellness website 10 parses the information received from employees 12, a healthcare insurer 14 and a marketing entity 16, and display the information on the wellness website 10. The wellness website 10 further provides access to the information received to the employees 12 and the marketing entity 16. Details of the information flow will be discussed further below.

The wellness website 10 initially receives the information from the healthcare insurer 14 and employees 12. The healthcare insurer 14 may be an insurance company, a medical service provider, or a third party administrator selected by an employer to provide healthcare benefits to the employees 12, with the employer partly or wholly paying a health premium to the healthcare insurer 14. It is contemplated that the employer itself may be a healthcare insurer. It is also contemplated that the employer may have more than one healthcare insurer 14.

The wellness website 10 receives healthcare benefit information from the healthcare insurer 14 via a communications link 30, and medical history information, nutritional intake information, and health indicator data from the employees 12 via a communications link 28. The communications link 30 and the communications link 28 may be electronic communication links via the internet or computer networks. The information received from the healthcare insurer 14 and the employees 12 may be transmitted through emails or other methods of electronic data transfer. The information may also be downloaded directly from the healthcare insurer 14 and the employees 12. Information may also be filled on a plurality of web forms on the wellness website 10. Moreover, the communications link 30 and the communications link 28 may also be using traditional mails to send paper documents containing the information from the healthcare insurer 14 and the employees 12 to a wellness service center 44, referring additionally now to FIG. 2. The wellness service center 44 may then parse the information and forward the information to the wellness website 10.

The healthcare benefit information received from the healthcare insurer 14 may be the employees' general healthcare coverage information. Healthcare coverage may be the same for all employees or may vary base on an individual employee's need. The healthcare benefit information may include, but not limited to, healthcare coverage information. The healthcare coverage information may specifically include co-pay amount for a variety of medical services, employee premium payment information, annual deductible limit information, claim procedure, physician profile and history, physical examination information, discount and promotions, baby care information, emergency care information, maternity care information, and any other healthcare related information.

The information received from the employees 12 is displayed on the wellness website 10. The information may include medical history information, nutritional intake information and health indicator data. By providing access to the information on the wellness website 10 to the employees 12, the employees 12 may monitor their own health and exercise preventive care by controlling their lifestyle. Details about the advantages and usage of the wellness website 10 will be discussed further below.

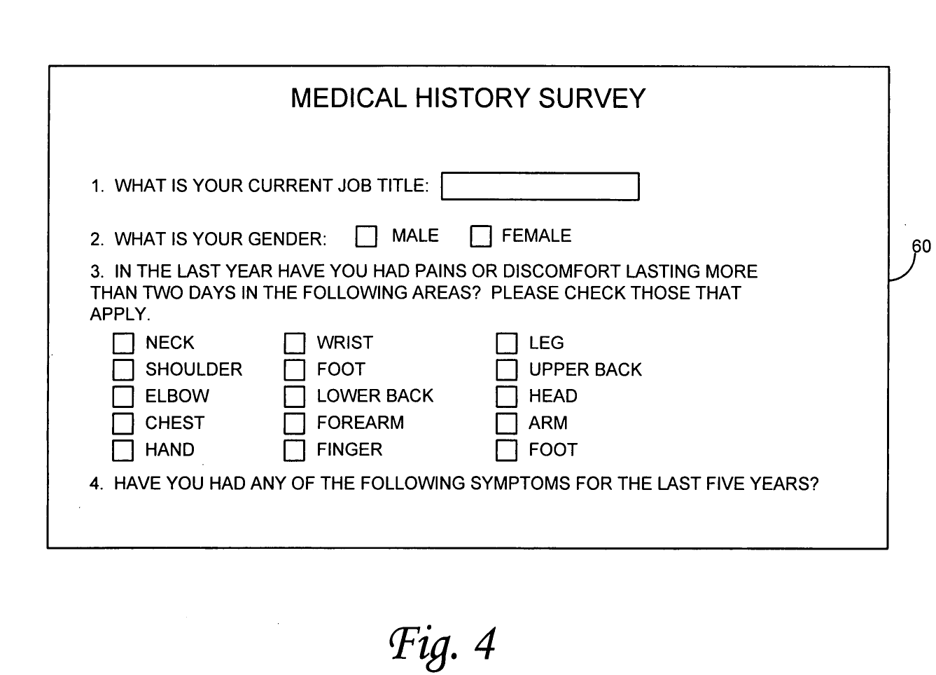

A way for the employees 12 to transmit the information may be entering the information directly on the plurality of web forms provided on the wellness website 10. An example of a web form is shown in FIG. 4, which depicts a sample medical history information form 60 used for enter medical history information of the employees 12. The sample medical history information form 60 is shown in a general questionnaire format, with question I and 2 gathering data on basic personal information and question 3 and 4 gathering data of prior illnesses and symptoms of the employees 12 and family members.

The medical history information received from the employees 12 may include, but not limited to, prior illnesses contracted by the employees 12, prior medical conditions of the employees 12, symptoms manifested by the employees 12 within a prior of time, known allergies information, prior clinical visit and hospitalization records, habits, addictions, and any other health related information of the employees 12. Examples of prior illness contracted by the employees 12 may include flu, diarrhea, viral infections, sexually transmitted diseases and other infectious diseases. Prior medical conditions may include prior heart conditions, lung diseases, liver diseases and other organ dysfunctions. Symptoms manifested by the employees 12 may include chest pains, dizziness, unconsciousness, shortness of breath, skin rashes, diarrhea and other physical manifestations. Habits and addictions information may include smoking, drinking, use of recreational drug, sleep habits, eating habits and other health related behaviors of the employees 12.

In addition, the wellness website 10 may receive the nutritional intake information from the employees 12 via the communications link 28. The nutritional intake information provides the employees a comprehensive view of their daily eating habits and may manifest the health risks and benefits that may be involved with the eating habits. The nutritional intake information may be frequently updated by the employees 12 to track their diet. The employees 12 may also be able to update the nutritional intake information on a nutrition tracking web form on the wellness website 10. The nutritional intake information may include, but not limited to, the employees' meal schedules, food selection, calorie intake information, fat intake information, carbohydrates intake information, fluid intake information, commercial vitamins intake information, and other diet related information Commercial vitamins may refer to artificially processed bottled vitamins available at fitness stores and pharmacies.

It is also contemplated that the wellness website 10 may receive health indicator data from the employees 12 via the communications link 28. In addition to the medical history information and the nutritional intake information, the employees 12 may track their health by enter the health indicator data on the wellness website 10. It is to the advantage of the employees 12 to submit the latest health indicator data that accurately reflects their current health status. By tracking the health indicator data, the employees 12 may improve their health by controlling their diet and exercise more. For example, an employee with a high cholesterol level, by comparing his health indicator data and his nutritional intake information, he may limit himself on dietary intake of seafood and red meat.

The health indicator data may include, but not limited to, weight, cholesterol level, electrocardiogram readings, blood pressure level, pulmonary function testing results, body mass index, blood oxygen level, and other common health indicators. The wellness website 10 may in addition generate a report providing pointers to the employees 12 of what may be the important health indicator data they need to be careful with.

Once the wellness website 10 receives information including the healthcare benefits information from the healthcare insurer 14, medical history information, health indicator data and nutritional intake information from the employees 12, the wellness website 10 may store the information in an online database 20. The online database 20 may be composed of a server 26 with an online software interface 22 providing access to its users via the internet or a computer network. The online database 20 may further include a HIPAA compliant firewall 24 to prevent unauthorized access. The HIPAA compliant firewall 24 may be built based on the guidelines set forth in the Health Insurance Portability and Accountability Act (HIPAA), a legislation passed to safeguard the security and confidentiality of a person's health information. The online software interface 22 may further provide login names and passwords to the employees 12 to maintain the confidentiality of their information. It is also contemplated that the online database 20 may be an electronic file with the information retrievable via a search engine. The online database 20 may also simply be a series of webpages retrievable via the search engine.

The method of the present invention facilitate the reduction of healthcare cost by licensing the information in the online database 20 to a marketing entity 16 for a licensing revenue. The marketing entity 16 may purchase the information for studying a trend of an illness and/or for performing targeted advertising toward the employees 12. The wellness website 10 provides access to the online database 20 to a marketing entity 16 via a communications link 38. However, the extent of the information that the marketing entity 16 may access depends on whether the employees 12 choose to share their information. The employees 12 may choose to keep their information private by not electing to share their information with the marketing entity 16 on the wellness website 10. The wellness website 10 may by default keep the information of the employees 12 private, unless the employees 12 indicated their intention otherwise.

The marketing entity 16 may provide rewards and rebates to the employees 12 who choose to share the information. Methods of providing rewards and rebates will be discussed in further details below. The marketing entity 16 may be a drug manufacturer, a research facility or any other interested parties. For example, if the marketing entity 16 a drug manufacturer marketing for a new drug for curing a disease, the marketing entity 16 may use the medical history information to select employees 12 who may have the disease. If the marketing entity 16 is a research facility looking for someone to be their test subjects, the marketing entity 16 may use the health indicator data to select employees 12 who match their requirement.

The communications link 38 may be an electronic communications link via the internet or a computer network. The communications link 38 may also be sending the information through emails or other forms of electronic documents to the marketing entity 16. The wellness website 10 may also provide a login name and a password to the marketing entity 16 so the marketing entity 16 may access the online database 20 via the online software interface 22. The communications link 38 may also constitute sending paper documents containing the information through conventional mails.

Once the marketing entity 16 receives the information, the marketing entity 16 may send tailored marketing data via a communications link 32 to the wellness website 10. The tailored marketing data may be a targeted advertisement based upon the information received from the employees 12. The tailored marketing data may be in an electronic form of a pop-up window software, banner software, advertising webpage links, scroll-down advertisement software, video or audio attachment, and other common forms of online advertisements. The tailored marketing data may also be in a conventional format of paper mails of which the wellness service center 44, referring additionally now to FIG. 2, may forward to the employees 12.

The content of the tailored marketing data may include, but not limited to, an advertisement for a new drug directed at a particular illness, an advertisement for a therapeutic method, an advertisement of a clinic or a physician, a tip on preventive care, a discount for medication and clinical visits, latest medical advancement information, an advertisement for a health-related event, an advertisement for a new product assisting a person with a particular disease, an information sheet looking for volunteer test subjects, and any other health related information.

The communications link 32 may be an electronic communications link via the internet or a computer network. The communications link 32 may be receiving the tailored marketing data through emails or other forms of electronic documents from the marketing entity 16. The communications link may also be an oral or written instruction provided by the marketing entity 16 to the wellness website 10, wherein the wellness website 10 may construct the tailored marketing data based upon the oral or written instruction.

To facilitate a reduction of healthcare cost, the method of the present invention helps the employees 12 exercising preventive care by allowing the employees 12 to monitor their own health. In accordance with the method of the current invention, the wellness website 10 provides access to information including the medical history information, nutritional intake information, and the healthcare benefit information to the employees 12 on the wellness website 10 via a communications link 36. By providing access to the information, the employees 12 may manage their own health profile, track their medical history and nutritional intake, and evaluate their healthcare benefits. For example, referring additionally now to FIG. 3, there is depicted a sample wellness webpage 56. The sample wellness webpage 56 displays the medical history information and the health indicator data to an employee. The sample wellness webpage 56 shows a family history of heart diseases with a potentially dangerous set of health indicators. By tracking and analyzing on the sample wellness webpage 56, this particular employee may realize his potential health risk of getting a heart disease and exercise corresponding preventive cares. The wellness website 10, by exposing potential health risks and providing tips on preventives care, helps the employees 12 to take control and improve their health. As for the employer, healthier employees means healthier workforce, which translates to better business efficiency and higher loyalty to the employer.

Another advantage of providing access to the information to the employees 12 is that the employees 12 may print out the information on the wellness website 10 and bring the information for their clinical visits. The wellness website 10 may also transmit the information to clinics at the request of the employees 12. The information may keep healthcare professionals better informed of the current health information of the employees 12.

As the employees 12 access the wellness website 10, the wellness website 10 may respectively display the tailored marketing data to the employees 12 who choose to receive the tailored marketing data. The method of the present invention helps the marketing entity 16 achieving higher marketing efficiency by selectively advertise to the employees 12. The employees 12 who choose to receive the tailored marketing data may also receive additional compensation from the marketing entity 16. Marketing compensation and flow of the licensing revenue will be discussed further. In addition, displaying the tailored marketing data on the wellness website 10 keeps the employees 12 better informed of the latest medical technology advancement. The employees 12 may then have a better understanding of their options in seeking medical treatment and preventive care.

The communications link 36 may primarily be providing access to the employees 12 to the wellness website 10 via the internet or a computer network. However, the communications link 36 may also be providing paper copies of the information to the employees 12. The wellness website 10 may provide login names and passwords to the employees 12 to prevent unauthorized access. In order to respectively display the tailored marketing data, the wellness website 10 may employ a parsing software linking the tailored marketing data to a targeted employee, such that the tailored marketing data automatically loads as the targeted employee access the wellness website 10. For example, referring now to FIG. 3, the sample wellness webpage 56 is displayed with a banner advertisement 58. The banner advertisement markets a new drug for treating heart disease because the medical history information on the sample wellness webpage 56 indicates a family history of heart diseases for this employee.

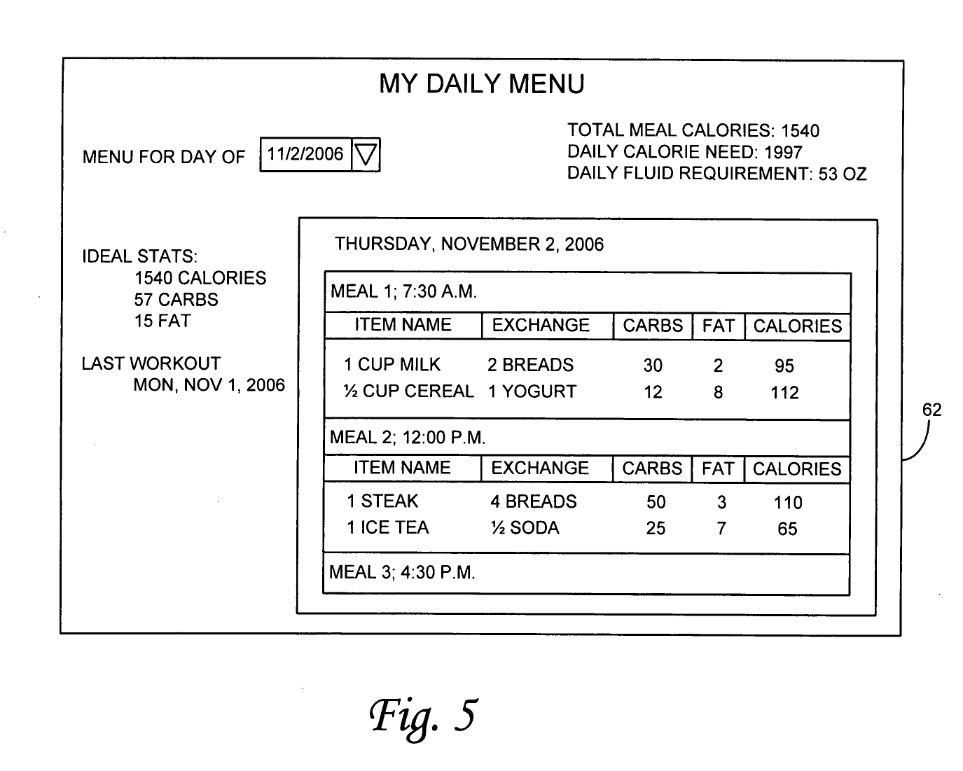

In accordance with the present invention, the wellness website 10 may provide access to tailored workout programs and tailored diet plans via the communications link 36 to the employees 12. The tailored workout programs and tailored diet plans may be generated based upon the information respectively received from the employees 12. The information may include the medical history information, nutritional intake information and the health indicator data. The tailored diet plans and the tailored workout programs are designed to improve the health of the employees 12 base upon an individual employee's need. For example, referring now to FIG. 5, there is depicted a sample daily menu 62 for an employee. The sample daily menu 62 displays the ideal consumption of calories, carbohydrates and fat each day for this employee. A right column of the sample daily menu 62 lists today's date, recommended time of each meal, recommended selection of food and available substitution, and the calorie, carbohydrates and fat count of each food selection. This employee may track and compare their daily intake of nutrition to what the sample daily menu 62 recommends, and make informed decisions on a dietary plan that leads to a healthier life. The tailored diet plans may include, but not limited to, dietary intake information and dietary restriction information. The wellness website 10 may further generate a report tracking the progress of the employees 12 by comparing the nutritional intake information and the tailored diet plans.

Similarly, the wellness website 10 may generate tailored workout programs to improve the health of the employees 12. The workout programs may include running, weight lifting, swimming, and other exercise programs, depending on each individual need of the employees 12. The employees 10 may also track their progress by entering their exercise activities on the wellness website 10.

The wellness website 10 may in addition provide access to tailored health risk information to the employees 12 on the wellness website 10 via the communications link 36. The tailored health risk information may be computed based upon the health indicator data of the employees 12. For example, the tailored health risk information may emphasize on a risk of heart disease for an employee who has high cholesterol, high blood pressure and overweight. The tailored health risk information may also include, but not limited to, the risk of the employees 12 of getting lung cancer, diabetes and other illnesses.

It is also contemplated that the wellness website 10 may receive medical record data from a professional healthcare entity 18 via the communications link 34, and provide access to the medical record data to the employees 12. Having the professional healthcare entity 18 updating the medical record data of the employees 12 on the wellness website allows the employees 12 to monitor and review their health status closely. In the event that the health indicator data reported by the employees 12 are out of date or erroneously entered, the employees 12 may view their medical record data submitted by the professional healthcare entity 18 to update the health indicator data on the wellness website 10. The employees 12 may also compare and review the medical records to assess the quality of the professional healthcare entity 18, track periodic visits and monitor their own health.

The professional healthcare entity 18 may be a physician, a hospital, a pharmacy, a laboratory or other entities providing healthcare service to the employees 12. The medical record data may be health indicator data, but may also include time, period and length of clinical visits, reason for clinical visits, treatment recommended and currently doing, name and location of the professional healthcare entity 18, cost of visits, blood test results, urine test results, known drug allergies, or any health service related information.

The wellness website 10 may in addition receive prescription data from the professional healthcare entity 18 via the communications link 34. The employees 12 may review their prescription on the wellness website 10, and have their prescription filled and be picked up or delivered to their home through the wellness website 10. The wellness website 10 may do so by forwarding the prescription data to a local pharmacy. The wellness website 10 may also set up an online pharmacy and deliver the medication based on the prescription data.

The wellness website may in addition provide access to the medical record data and the health indicator data of the employees 12 via a communications link 40 to the professional healthcare entity 18. The professional healthcare entity 18 may be able to evaluate the overall health of the employees 12 through the medical record data and the health indicator data, and provide effective health advice to the employees 12.

Referring additionally now to FIG. 2, there is depicted a flow chart illustrating the flow of cost between the entities. The method of the present invention is specifically adapted to reduce healthcare costs of the employer 42 and the employees 12 by shifting the burden partly or wholly to the marketing entity 16. The wellness service center 44 receives a licensing revenue from the marketing entity 16, and forward a percentage of the licensing revenue to the employees 12, the healthcare insurer 14, and the employer 42, thereby reducing or completely eliminating health premium payments.

As shown in FIG. 2, the employees 12 and the employer 42 pay healthcare premiums to the healthcare insurer 14 via a symbolic payment link 46 and a symbolic payment link 60 respectively. By receiving the licensing revenue from the marketing entity 16, the healthcare premium of the employees 12 and the employer 42 may be discounted or even completely eliminated. The licensing revenue, denoted by the symbolic payment link 52, may come from several sources. One source of the licensing revenue may come from providing the marketing entity 16 with access to the medical history information, the nutritional intake information, and the health indicator data of the employees 12. Another source of the licensing revenue may come from targeted advertisement to the employees 12, either from placing the tailored marketing data on the wellness website 10, or from providing contact information of the employees 12 to the marketing entity 16, who may then advertise directly to the employees 12 through emails, mails, phone calls, and/or other methods of advertising. Another source of the licensing revenue may come from hosting marketing activities include hosting an online or printed survey or questionnaire with the employees 12, and participating in a research group. Details of the marketing activities will be discussed further below.

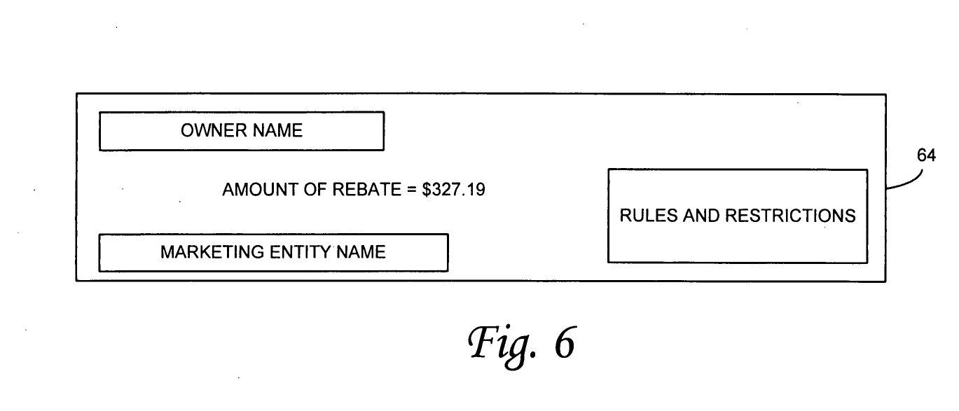

The wellness service center 44 receives the licensing revenue, and forward a percentage of the licensing revenue to the employer 42 via a symbolic payment link 50, the employees 12 via a symbolic payment link 46, and/or the healthcare insurer 14 via a symbolic payment link 48. The symbolic payment links 44, 54 and 42 may be a rebate, a coupon discounting or eliminating of the healthcare premium paid by the employees 12 and the employer 42 to the healthcare insurer 14, a waiver of co-payments of the employees 12 during a clinical visit, a discounted or free physical examination, a gift, cash, or a combination thereof. It is contemplated that other form of compensation may also be available. For example, referring additionally now to FIG. 6, there is depicted a sample rebate 64. The sample rebate 64 displays the name of the owner of the rebate 64, the name of the marketing entity 16 who sponsored the sample rebate 64, the worth of the sample rebate 64, and rules and restriction on the use of the sample rebate 64. The healthcare insurer 14 may further compensate the employer 42 via a symbolic payment link 58 and the employees 12 via a symbolic payment link 56.

An example of a marketing activity is clicking on a banner advertisement provided by the marketing entity 16 as a tailored marketing data. By clicking on the banner advertisement, the employees 12 may receive additional compensation from the marketing entity 16. Another example of a marketing activity may be participating in a marketing survey. The marketing survey may be provided by the marketing entity 16 to the wellness website 10. The wellness website 10 may then provide the marketing survey to the employees 12, collect the results, and forward the results back to the marketing entity 16.

In an embodiment of the method of the present invention, a reward system may be established to compensate the employees 12 for their participation in the marketing activities. For example, the employees 12 may earn points for activities in which they participate with the wellness website 10. The point system may be established so that the employees 12 earn one point for updating their medical history information on the wellness website 10, one point for entering their nutritional intake information, one point for updating their health indicator data, one point for tracking the progress of a tailored diet plan, one point for tracking the progress of a tailored workout program, two points for receiving opt-in marketing emails from the marketing entity 16, two points for clicking on a banner advertisement, two points for receiving direct marketing mails from the marketing entity 16, 10 points for participating in an optional marketing survey, fifteen points for clicking on a link of the tailored marketing data and twenty-five points for purchasing a product marketed by the marketing entity 16. At the end of a predetermined period of time, the employees 12 may receive $0.015 per point in a form of rebate or cash for the accumulated points during the predetermined period of time.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for managing employee healthcare for an employer, the method comprising the steps of:
a) receiving healthcare benefit information from a healthcare insurer, the healthcare insurer providing healthcare benefits to employees of the employer;
b) receiving medical history information from the employees;
c) storing the medical history information and the healthcare benefit information in an online database;
d) providing access to the online database to a marketing entity;
e) receiving tailored marketing data based upon the medical history information of each of the employees from the marketing entity; and
f) providing access to the medical history information and the healthcare benefit information to the employees on a website, the website respectively displaying the tailored marketing data to the employees on the website when the employees respectively access any of the medical history information and healthcare benefit information.

2. The method of claim 1 wherein step (a) comprises electronically receiving the healthcare benefit information via a computer network.

3. The method of claim 1 wherein step (b) comprises electronically receiving the medical history information via a computer network.

4. The method of claim 1 wherein step (d) comprises providing access to the online database to the marketing entity through a marketing interface on the website, the marketing interface displaying the medical history information to the marketing entity.

5. The method of claim 1 wherein step (e) comprises electronically receiving the tailored marketing data via a computer network.

6. The method of claim 1 wherein the marketing entity is a research facility.

7. The method of claim 1 wherein the marketing entity is a drug manufacturer.

8. The method of claim 1 wherein the tailored marketing data is a banner advertisement on the website.

9. The method of claim 1 further comprising a step of receiving nutritional intake information from the employees.

10. The method of claim 9 further comprises a step of providing access to tailored workout programs to the employees on the website, the tailored workout programs being generated based upon the nutritional intake information of each of the employees.

11. The method of claim 9 further comprising a step of providing access to tailored diet plans to the employees on the website, the tailored diet plans being generated based upon the nutritional intake information of each of the employees.

12. The method of claim 1 further comprising a step of receiving a licensing revenue from the marketing entity, the licensing revenue being generated from providing access to the online database to the marketing entity.

13. The method of claim 12 further comprising a step of forwarding a first percentage of the licensing revenue to the employer.

14. The method of claim 12 further comprising a step of forwarding a second percentage of the licensing revenue to the employees.

15. The method of claim 12 further comprising a step of forwarding a third percentage of the licensing revenue to the healthcare insurer.

16. The method of claim 1 further comprising a step of receiving health indicator data from the employees.

17. The method of claim 16 further comprising a step of providing access to tailored health risk information to the employees on the website, the tailored health risk information being computed based upon the health indicator data of each of the employees.

18. The method of claim 1 further comprising a step of providing a marketing survey to the employees on the website.

19. The method of claim 18 further comprising a step of receiving marketing survey data from the employees.

20. The method of claim 19 further comprising a step of receiving a rebate from the marketing entity, the rebate being generated from providing the marketing survey data to the marketing entity.

21. The method of claim 20 further comprising a step of forwarding a first portion of the rebate to the employees.

22. The method of claim 21 further comprising a step of forwarding a second portion of the rebate to the employer.

23. The method of claim 1 further comprising a step of receiving medical record data from a professional healthcare entity, the professional healthcare entity providing healthcare service to the employees.

24. The method of claim 23 further comprising a step of receiving prescription data of each of the employees from the professional healthcare entity.

25. The method of claim 24 further comprising a step of providing medication to the employees based on the prescription data of each of the employees.
